(19) United States
(12) Patent Application Publication
(10) Pub. No.: US 2014/0211397 A1
(43) Pub. Date: Jul. 31, 2014

(54) ELECTRONIC DEVICE AND INDICATING METHOD FOR CONNECTORS

(71) Applicant: HON HAI PRECISION INDUSTRY CO., LTD., New Taipei (TW)

(72) Inventors: TAY-YANG LIN, New Taipei (TW); CHIN-FENG CHEN, New Taipei (TW); CHIA-JUNG LIU, New Taipei (TW); SHU-MING LIU, New Taipei (TW); HSIN-CHIH HSU, New Taipei (TW)

(73) Assignee: HON HAI PRECISION INDUSTRY CO., LTD., New Taipei (TW)

(21) Appl. No.: 14/160,786

(22) Filed: Jan. 22, 2014

(30) Foreign Application Priority Data
Jan. 30, 2013 (TW) 102103396

(51) Int. Cl. G06F 1/16

(52) U.S. Cl. CPC G06F 1/16
USPC 361/679.21

(57) ABSTRACT

An electronic device includes a housing, a connector and an indicating structure. The connector is mounted to the housing. The indicating structure is located on the housing corresponding to the connector. The indicating structure includes a proximity switch and a luminescent component. The proximity switch is configured to switch on the luminescent component when detecting presence of a nearby peripheral connector. The peripheral connector is easily coupled to the connector.

### BACKGROUND

The disclosed embodiments relate generally to an electronic device and an indicating method for connectors of the electronic device.

### DESCRIPTION OF RELATED ART

In order to interface different peripherals to computers, different connectors such as Universal Serial Bus (USB), Institute of Electric Electronic Engineer (IEEE) Ethernet, Digital Visual Interface (DVI), and High Definition Multimedia Interface (HDMI), for example, are used. However, such connectors are often installed at the back or sides of an equipment, an area where the user faces positioning difficulty when plugging and unplugging the connectors. Particularly, there is no indicators corresponding to the connectors which are easily visual from a top of the equipment, whereby plugging proper male connectors to corresponding socket connectors in the equipment is difficult and burdensome. There is room for improvements within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an electronic device in a first embodiment.

FIG. 2 is similar to FIG. 1, but the electronic device being shown in a working state when a peripheral device moves in.

FIG. 3 is a partial top view of the electronic device of FIG. 1.

FIG. 4 is a partial top view of an electronic device in a second embodiment.

FIG. 5 is a partial top view of an electronic device in a third embodiment.

FIG. 6 is a partial top view of an electronic device in a fourth embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

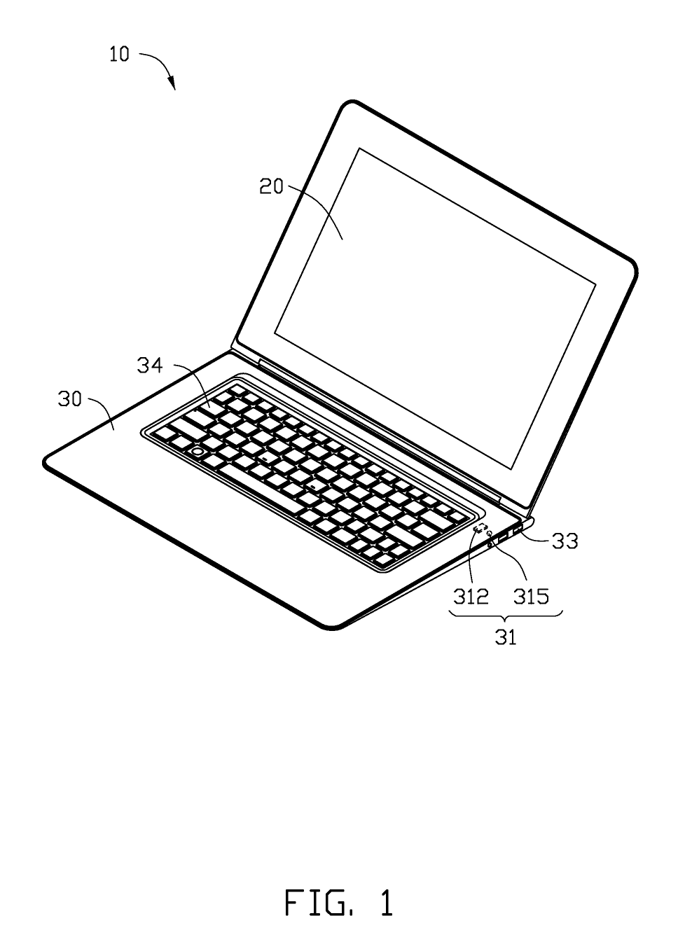

FIG. 1 is an isometric view of an electronic device 10 in accordance with one embodiment. The electronic device may be a laptop computer, a smart phone, or desktop computer, for example. In FIG. 1, it is a laptop computer. The electronic device 10 includes a top housing 20 and a bottom housing 30. The bottom housing 30 includes a keyboard module 34, a plurality of connectors 33 located on a lateral side of the keyboard module 34, and an indicating structure 31 on a side of the plurality of connectors 33.

The connectors 33 may be one of or Universal Serial Bus (USB), Institute of Electric Electronic Engineer (IEEE) Ethernet, Digital Visual Interface (DVI), High Definition Multimedia Interface (HDMI), and other connectors.

The indicating structure 31 includes at least one proximity switch 312 and at least one luminescent component 315. The luminescent component 315 may be a light-emitting diode (LED) light.

The proximity switch 312 can detect presence of a nearby object without physical contact and switch on or off the luminescent component 315. The proximity switch 312 includes a metal detector. The metal detector is a portable electronic instrument which detects the presence of metal nearby. The metal detector includes an oscillator producing an alternating current that passes through a coil producing an alternating magnetic field. If a piece of electrically conductive metal is close to the coil, eddy currents will be induced in the metal, and this produces a magnetic field of its own. If another coil is used to measure the magnetic field, the change in the magnetic field due to the metallic object can be detected.

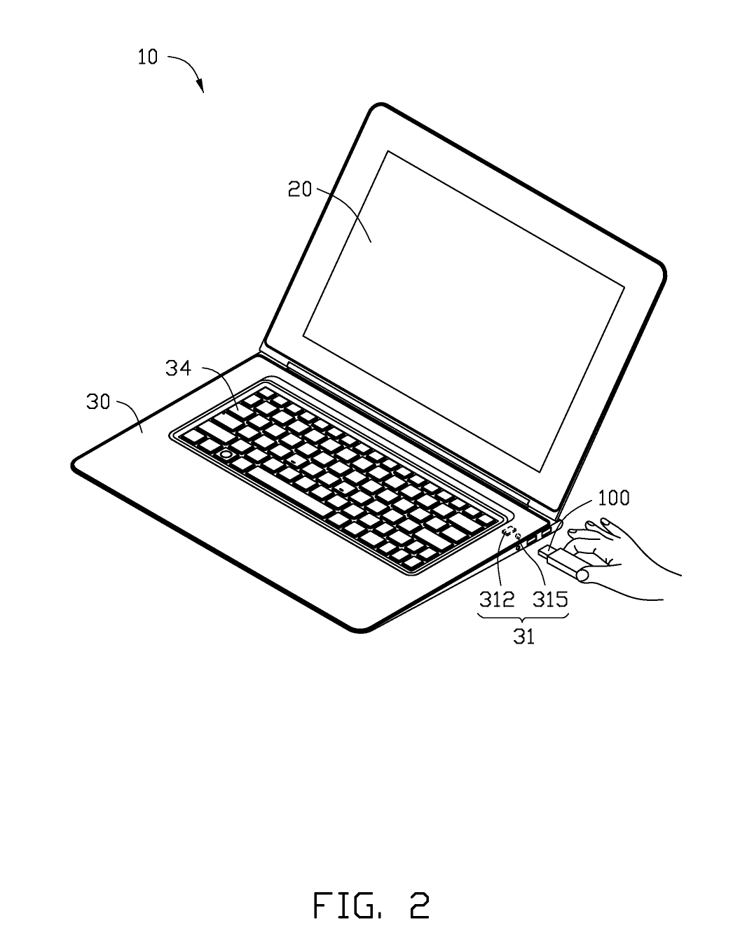

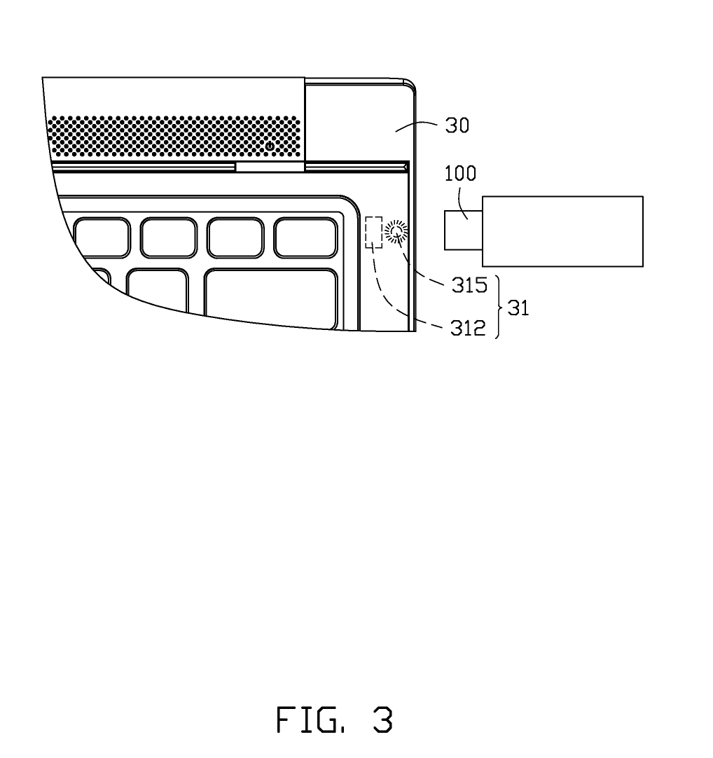

FIG. 2 and FIG. 3 illustrate a detecting state of the proximity switch 312 from two aspects. When a periphery device with a peripheral connector 100 is moved near the proximity switch 312, the proximity switch 312 detects the peripheral connector 100 and switches on the luminescent component 315 to indicate the location of the connector 33. The luminescent component 315 indicates the user from a top of the bottom housing 30.

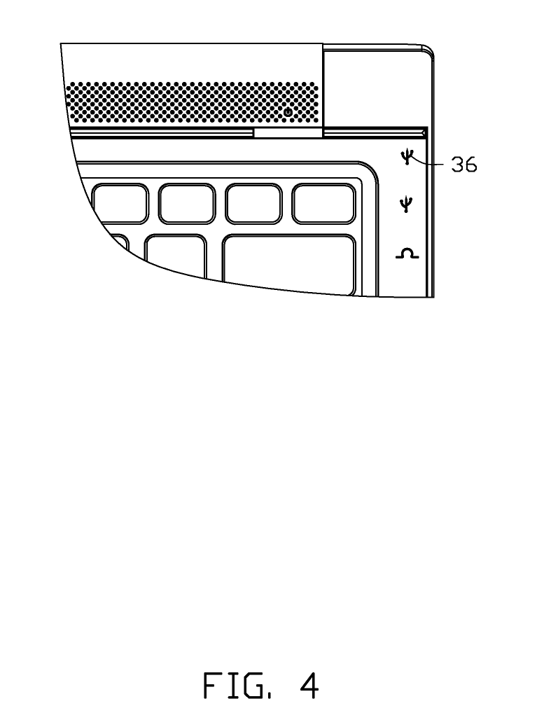

FIGS. 4 to 6 illustrate three types of indicators on the housing 30 in other embodiments. FIG. 4 shows that the bottom housing 30 includes a type indicator 36 adjacent to the connectors 33. The luminescent component 315 (not shown) is located under the type indicator 36. The type indicator 36 indicates a type of corresponding connector 33 when the luminescent component 315 illuminates. The type indicator 36 is transparent, made of transparent plastic or transparent glass. The type indicator 36 in the shown embodiment includes two USB indicators and an earphone jack indicator, corresponding to two USB connectors and an earphone jack, respectively.

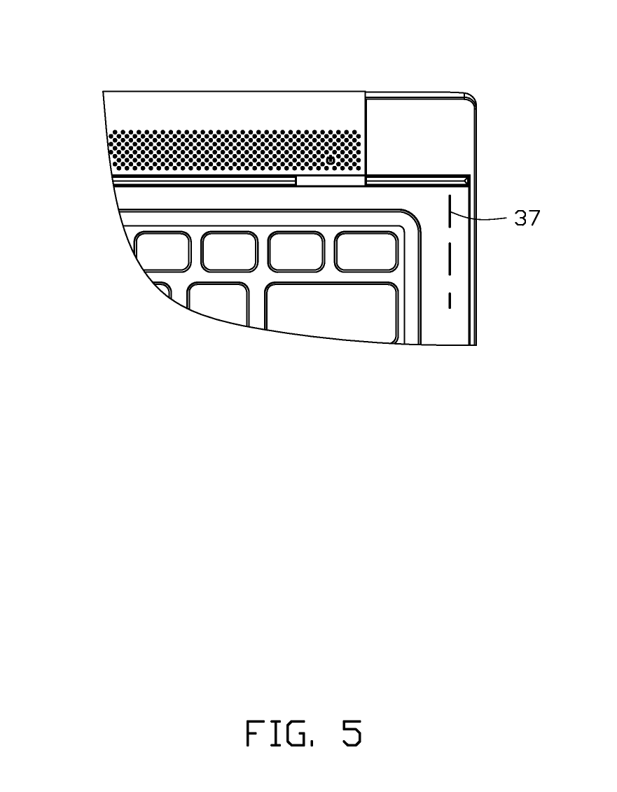

FIG. 5 shows that the bottom housing 30 includes a width indicator 37 adjacent to the connectors 33. The luminescent component 315 (not shown) is located under the width indicator 37. The width indicator 37 indicates a width of a corresponding connector 33 when the luminescent component 315 illuminates. The width indicator 37 is transparent. The width indicator 37 in the shown embodiment includes three width indicators with different widths from each other, wherein two indicators have the same width which is longer that the width of the other (third) indicator. The two longer width indicators are for the USB connectors and the shorter width indicator is for the earphone jack.

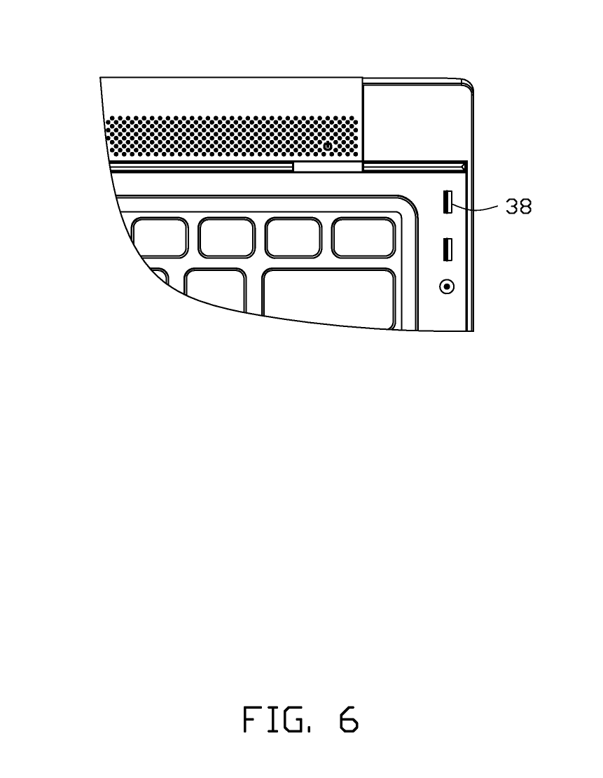

FIG. 6 shows that the bottom housing 30 includes an orientation indicator 38 adjacent to the connectors 33. The luminescent component 315 (not shown) is located under the orientation indicator 38. The orientation indicator 38 indicates a plugging direction of a corresponding connector 33 when the luminescent component 315 illuminates. The orientation indicator 38 is transparent. In the shown embodiment, the orientation indicator 38 includes two rectangular ones each for indicating the insertion direction of a USB connector, and a circular one for indicating the insertion direction of an audio plug.

In another embodiment, the luminescent component 315 can illustrate different colors. Each color of the luminescent components 315 can indicate one type of connector 33. For example, green light indicates all USB ports, and blue indicates all HDMI ports.

A detecting method includes the following steps.

Step S101: the proximity switch 312 detects presence of the peripheral connector 100 near a connector 33.

Step S103: the proximity switch 312 switches on the luminescent component 315 near the connector 33 to indicate the connector 33.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. An electronic device, comprising:
a housing;
a connector mounted to the housing; and
an indicating structure located on the housing corresponding to the connector, and the indicating structure comprising a proximity switch and a luminescent component;
wherein the proximity switch is configured to switch on the luminescent component to indicate the connector when detecting presence of a nearby peripheral connector, which is configured to be coupled to the connector.

2. The electronic device of claim 1, wherein the connector is located on a lateral side of the housing, and the luminescent component is configured to illuminate from a top side of the housing.

3. The electronic device of claim 1, wherein the housing comprises an orientation indicator adjacent to the connector to indicate a plugging direction of the connector when the luminescent component illuminates.

4. The electronic device of claim 3, wherein the orientation indicator is transparent.

5. The electronic device of claim 1, wherein the housing comprises a type indicator adjacent to the connector to indicate a type of the connector when the luminescent component illuminates.

6. The electronic device of claim 5, wherein the type indicator is transparent.

7. The electronic device of claim 1, wherein the housing comprises a width indicator adjacent to the connector to indicate a width of the connector when the luminescent component illuminates.

8. The electronic device of claim 5, wherein the width indicator is transparent.

9. The electronic device of claim 1, wherein the proximity switch comprises a metal detector for detecting the nearby peripheral connector.

10. A detecting method for detecting an approach of a peripheral connector to a mating connector in an equipment, comprising:
detecting the approach of the peripheral connector to the mating connector by a proximity switch; and
switching on a luminescent component near the mating connector to indicate the mating connector.

11. The detecting method of claim 10, wherein the mating connector is located on a lateral side of a housing of the equipment, and the luminescent component is configured to illuminate from a top side of the housing.

12. The detecting method of claim 11, wherein the housing comprises an orientation indicator adjacent to the mating connector to indicate a plugging direction of the peripheral connector when the luminescent component illuminates.

13. The detecting method of claim 12, wherein the orientation indicator is transparent.

14. The detecting method of claim 11, wherein the housing comprises a type indicator adjacent to the mating connector to indicate a type of the mating connector when the luminescent component illuminates.

15. The detecting method of claim 14, wherein the type indicator is transparent.

16. The detecting method of claim 11, wherein the housing comprises a width indicator adjacent to the mating connector to indicate a width of the mating connector when the luminescent component illuminates.

17. The detecting method of claim 16, wherein the width indicator is transparent.

18. The detecting method of claim 11, wherein the proximity switch comprises a metal detector for detecting the approach of the peripheral connector to the mating connector.
